(19) United States
(12) Patent Application Publication
(10) Pub. No.: US 2016/0357492 A1
(43) Pub. Date: Dec. 8, 2016

(54) DISPLAY SYSTEM AND METHOD FOR AN AIRCRAFT

(71) Applicant: AIRBUS OPERATIONS (S.A.S.), Toulouse Cedex 9 (FR)

(72) Inventors: Christine CHARBONNIER, SAINT LYS (FR); Aymeric PERRIN, BLAGNAC (FR); Cedric DESCHEEMAEKER, BEAUZELLE (FR); Nicolas ANTONI, TOURNEFEUILLE (FR)

(21) Appl. No.: 15/167,541

(22) Filed: May 27, 2016

(30) Foreign Application Priority Data
Jun. 8, 2015 (FR) 15 55177

(51) Int. Cl. G06F 3/14; B64D 43/00; G06F 3/0481

(52) U.S. Cl. CPC G06F 3/1423; G06F 3/0481; B64D 43/00; G06F 2203/04803

(57) ABSTRACT

A display system and method including screens in a cockpit of an aircraft. A control unit is configured to command the display according to a normal display mode, wherein the control unit is configured so as to command the display such that subsequent to the occurrence of an event on board the aircraft leading to the display of an interactive element in an interaction window, the control unit commands the display of the interaction window on one of the screens of the screens at least while an action by an operator is required on the interactive element, and a reconfigured display mode, wherein the control unit is configured to command the display, on a second screen including a signaling area, of a display window that is normally displayed on a first screen in the normal display mode, and to command the display of an indicator in the signaling area if the interaction window is not displayed on a screen of the screens when an action by an operator is required on the interactive element.

### CROSS-REFERENCE TO RELATED APPLICATION

This application claims the benefit of and priority to French patent application No. 15 55177 filed on Jun. 8, 2015, the entire disclosure of which is incorporated by reference herein.

### TECHNICAL FIELD

The disclosure herein relates to a display system and method for an aircraft, as well as to an aircraft comprising such a system.

### BACKGROUND

Aircraft, in particular modern transport airplanes, comprise a system for managing the display in the cockpit of CDS (Control and Display System) type. The CDS comprises a plurality of screens in the cockpit of the aircraft, as well as a control unit that is configured so as to command the display on these screens. In a normal display mode corresponding, in particular, to the absence of screen failure, the control unit is configured so as to command the display of at least one display window on each of the screens. Each display window is allocated to one or more systems of the aircraft, and it may be of fixed or variable size. On the occurrence of an event on board the aircraft for which an action by an operator is required (e.g. a warning), an aircraft computer charged with monitoring the event, e.g. a warning management computer of FWS (Flight Warning System) type sends a request to the control unit of the CDS in order to display an interactive element in at least one display window. This display window is referred to as the interaction window throughout the remainder of this document. The control unit commands the display of the interaction window comprising the interactive element on one of the screens of the cockpit, at least while an action by an operator is required on the interactive element. Thus, following the occurrence of an event, an operator such as, in particular, a pilot of the aircraft may carry out an action on board the aircraft by acting on the interactive element by a human-machine interface in the cockpit. This action corresponds, for example, to an acknowledgment of a warning or to a modification in the state of a system of the aircraft (e.g. the shutdown of an engine, the opening or closing of a valve, etc.). The interactive element corresponds, for example, to a button displayed in the interaction window on which the operator may click. Generally, the interaction window also comprises at least one indicator allowing the operator to understand the nature of the event.

In the event of failure of one or more screens of the cockpit, the control unit commands the display on the other, functioning, screens according to a reconfigured display mode. Such a display mode is in particular described by the document FR2,892,092. When a non-functioning screen corresponds to a screen on which, in the normal display mode, a display window that is considered to have priority is displayed, then the display is reconfigured in such a way that the display window is displayed on another, functioning, screen instead of a display window that has lower priority. A human-machine interface, e.g. a push-button, connected to the control unit of the CDS allows the pilot to view, on this other screen, other displays window(s). Thus, each press by the pilot on this push-button allows the display window displayed on this other screen to be changed, according to a predefined order. The pilot may thus scroll through and view all of the display windows that are normally displayed on the various screens of the cockpit in the normal display mode.

The activation of the reconfigured display mode may also correspond, aside from in the event of failure of a screen, to a voluntary request by the pilot to display, on one of the screens of the cockpit, a display window that is normally displayed on a portable device of EFB (Electronic Flight Bag) type. The corresponding display window is then displayed instead of a display window that is normally displayed on this screen of the cockpit in the normal display mode.

When the display is carried out according to the reconfigured display mode, the interactive element that is displayed in the interaction window may not be accessible to a pilot of the aircraft if the interaction window is not displayed on a screen of the cockpit due to the reconfiguration of the display. Indicators are given in the cockpit so as to warn the pilot of the occurrence of the event, generally in the form of a visual and/or acoustic indicator: the pilot must then act on the human-machine interface in order to view the interaction window. If the event occurs at a moment when the pilot's workload is high, the pilot may wish to carry out the actions relating to this event at a later time. However, so as not to be disturbed by the visual or acoustic indicator while he or she carries out other actions, the pilot may sometimes dismiss this visual or acoustic indicator: he or she must then memorize the fact that he or she received this visual or acoustic indicator so as not to forget to request the display of the interaction window at a later time. Additionally, the display of the interaction window may require multiple actions by the pilot on the human-machine interface in order to scroll through multiple windows until the interaction window is displayed and, moreover, the pilot does not know in advance how many actions will be required on this human-machine interface so that the interaction window is displayed on a screen of the cockpit. Specifically, as pointed out above, the various display windows that are able to be viewed on a screen in reconfigured display mode are displayed according to a predefined order during the successive actions by the pilot on the human-machine interface, but the pilot does not know this predefined order, especially as this may depend on the number of non-functioning screens in the cockpit and the position of the non-functioning screen(s). The successive actions on the human-machine interface generate an additional workload for the pilot, especially as the pilot must additionally watch out for the appearance of the interaction window on the display inasmuch as he does not know in advance, on the one hand, how many actions are required on the human-machine interface in order to obtain the display of the interaction window and, on the other hand, on which screen the interaction window will be displayed.

### SUMMARY

A particular aim or object of the present disclosure is to provide a solution to these problems. It relates to a display system for an aircraft, this display system comprising a plurality of screens in a cockpit of the aircraft, among which at least a first screen and a second screen, the display system also comprising a control unit that is configured so as to command the display on the screens of the plurality of screens according to a normal display mode or according to a reconfigured display mode, in such a way that:

in the normal display mode, the control unit is configured so as to command the display of at least one display window on each of the screens of the plurality of screens, in such a way that subsequent to the occurrence of an event on board the aircraft leading to the display of an interactive element in an interaction window, the control unit commands the display of the interaction window on one of the screens of the plurality of screens at least while an action by an operator is required on the interactive element; and

in the reconfigured display mode, the control unit is configured so as to command the display, on the second screen of the plurality of screens, of a display window that is normally displayed on the first screen in the normal display mode.

This display system is noteworthy in that the second screen comprises a signaling area and, in the reconfigured display mode, the control unit is configured so as to command the display of an indicator in the signaling area if the interaction window is not displayed on a screen of the plurality of screens when an action by an operator is required on the interactive element.

Thus, by virtue of this system, the pilot of the aircraft is informed of the fact that an action is required on his or her part in the interaction window and that, to this end, he or she must carry out an action to display this interaction window.

Advantageously, the display system comprises a human-machine interface connected to a control unit and, in the reconfigured display mode, the control unit is configured so as to command the display of the interaction window when it receives information from the human-machine interface corresponding to an action by an operator on the human-machine interface. Thus, the pilot may directly display the interaction window by carrying out this action on the human-machine interface, without having to scroll through other display windows on the screen. This therefore allows time to be gained and the pilot's workload to be reduced. In one embodiment, the control unit is configured so as to command the display of the interaction window on the second screen when it receives information from the human-machine interface corresponding to an action by an operator on the human-machine interface. Displaying the interaction window on the second screen rather than on another screen improves the ergonomics of the system by allowing the pilot to directly view the interaction window without having to search for it on another screen.

In one particular embodiment of the disclosure herein, the signaling area comprises an interactive element that is actionable using the human-machine interface. Thus, the action by the operator on the human-machine interface may then correspond to an action by the pilot on this interactive element of the signaling area. The pilot may then directly act on this interactive element of the signaling area in order to request the display of the interaction window. This allows the ergonomics of the display system to be improved further.

In one embodiment, the control unit comprises a memory containing an ordered list of display windows that are associated with a second screen in the reconfigured display mode and the control unit is configured so as to modify the display of the second screen, in the reconfigured display mode, during an action by an operator on the human-machine interface:

by displaying, on the second screen, a display window that is consecutive, in the ordered list, to a current window that is displayed during the action by the operator on the human-machine interface, when no action by an operator is required on the interactive element of the display window;

by displaying, on the second screen, the interaction window when an action by an operator is required on this interactive element.

Preferably, the ordered list of display windows contains the interaction window.

In one advantageous embodiment, the second screen comprises a first display area and a second display area, each suitable for displaying at least one display window, and the signaling area is positioned between the first display area and the second display area. This embodiment is particularly compatible with the use of screens of large size in the cockpit, each envisaged to display multiple display windows. Advantageously, the signaling area is able to be configured so as to be combined with the first display area and/or the second display area. This allows a shared signaling area to be used for both display areas and, consequently, the screen surface area used for the signaling area to be limited.

In one particular embodiment, the control unit is configured so as to receive information on the state of the screens of the plurality of screens and to detect potential failure of a screen according to the state information, the control unit furthermore being configured so as to command the display on the screens of the plurality of screens according to the normal display mode in the absence of screen failure and to command the display on the screens of the plurality of screens according to the reconfigured display mode in the event of failure of at least one screen of the plurality of screens. The display system according to the disclosure herein is then particularly advantageous in the event of failure of one screen of the plurality of screens.

The disclosure herein also relates to an aircraft comprising a display system as described above.

The disclosure herein also relates to a display method for an aircraft having a display system comprising a plurality of screens in a cockpit of the aircraft, among which at least a first screen and a second screen, the display system also comprising a control unit, according to which method the control unit commands the display on the screens of the plurality of screens according to a normal display mode or according to a reconfigured display mode, in such a way that:

in the normal display mode, the control unit commands the display of at least one display window on each of the screens of the plurality of screens, in such a way that subsequent to the occurrence of an event on board the aircraft leading to the display of an interactive element in an interaction window, the control unit commands the display of the interaction window on one of the screens of the plurality of screens at least while an action by an operator is required on the interactive element; and

in the reconfigured display mode, the control unit commands the display, on the second screen of the plurality of screens, of a display window that is normally displayed on the first screen in the normal display mode.

The display method is noteworthy in that, the second screen comprising a signaling area, in the reconfigured display mode the control unit commands the display of an indicator in the signaling area if the interaction window is not displayed on a screen of the plurality of screens when an action by an operator is required on the interactive element.

### BRIEF DESCRIPTION OF THE DRAWINGS

The disclosure herein will be better understood upon reading the following description and upon examining the appended drawings.

FIG. 1 illustrates, in a simplified manner, an aircraft comprising a cockpit.

FIG. 2 represents a display system according to one embodiment of the disclosure herein.

FIGS. 3 and 4 each illustrate a screen of the cockpit of the aircraft displaying a signaling area according to embodiments of the disclosure herein.

FIG. 5 illustrates an example of a display on screens of the cockpit of the aircraft, in a normal display mode.

FIG. 6 illustrates an example of a display on screens of the cockpit of the aircraft, in a reconfigured display mode.

FIG. 7 illustrates an example of a successive display of multiple windows on a screen of the cockpit of the aircraft, in a reconfigured display mode.

FIGS. 8A through 8E illustrate various examples of a display in the signalling area of a screen of the cockpit, in the reconfigured display mode.

### DETAILED DESCRIPTION

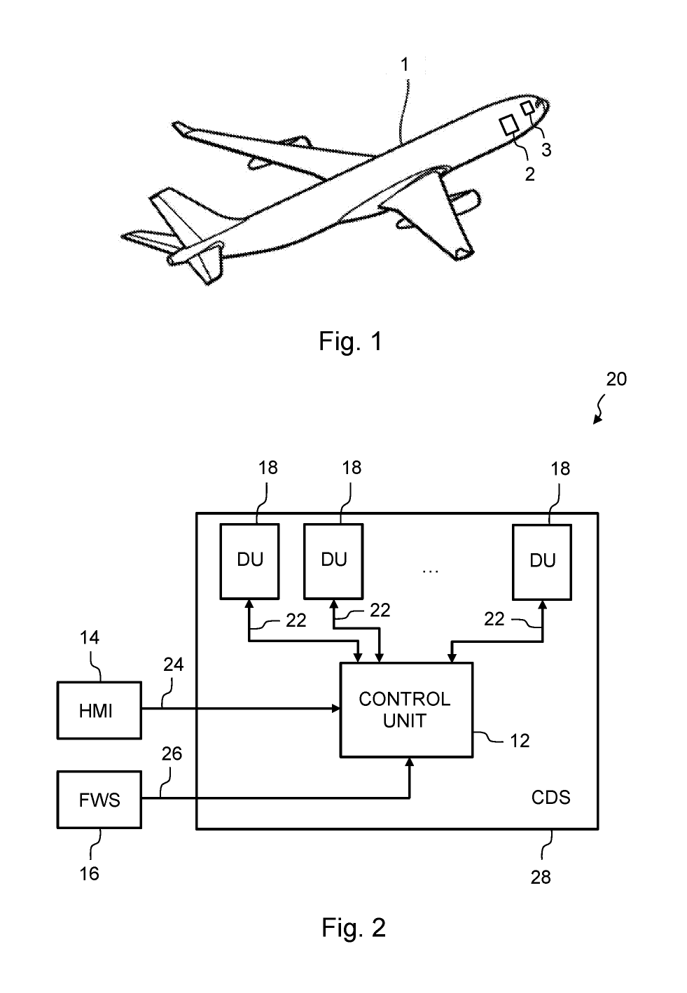

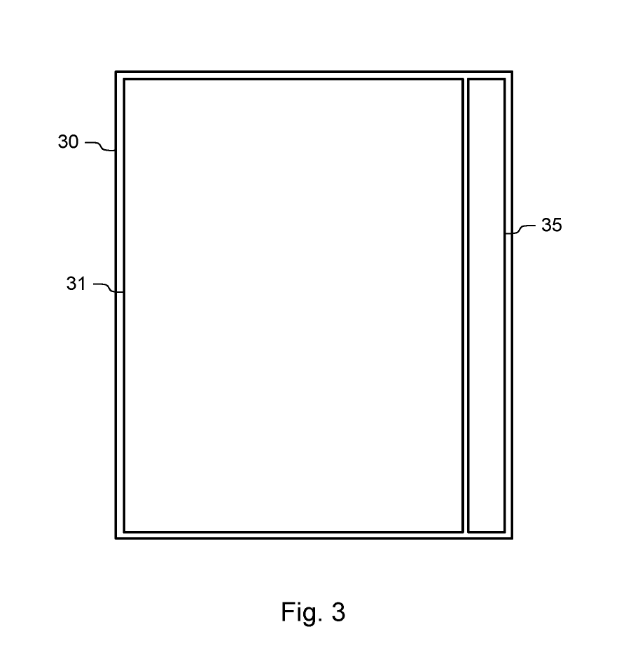

The aircraft 1 shown in FIG. 1 comprises a display system 20 such as shown in FIG. 2. The display system 20 comprises a display management system 28, e.g. of CDS (Cockpit Display System) type. The display management system comprises a control unit 12 and a plurality of display screens 18 (DU for Display Unit) that are located in the cockpit 3 of the aircraft. These display screens are connected to the control unit by a set of connections 22. The control unit 12 is also connected to a human-machine interface HMI 14 by a connection 24. The control unit 12 is also connected to a set of avionics computers, of which in particular a warning management computer of FWS (Flight Warning System) type via a connection 26. The control unit 12 may, for example, be located in an avionics bay 2 of the aircraft. It corresponds to an avionics computer or to a function that is implemented in a modular avionics computer.

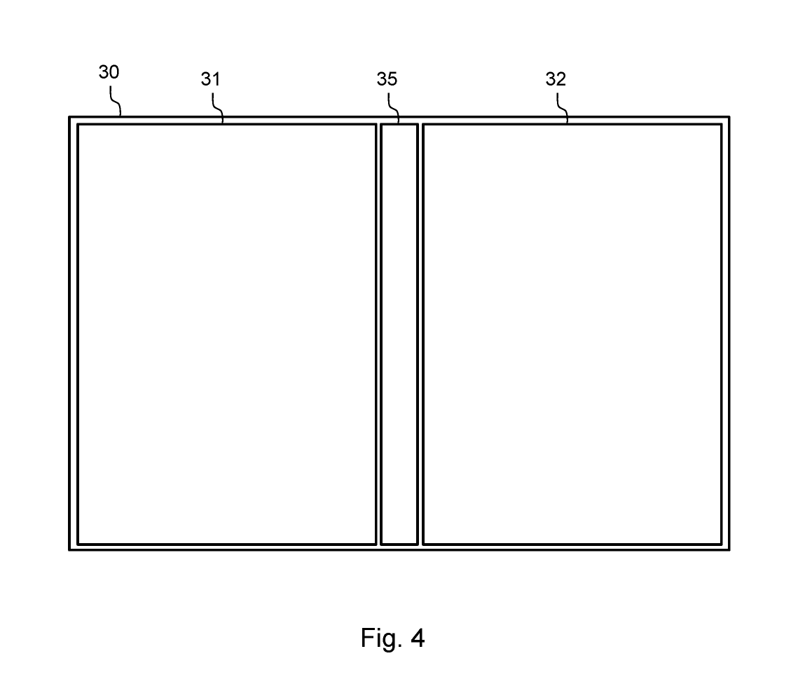

The plurality of display screens 18 of the cockpit comprise at least a first display screen and a second display screen. According to one embodiment of the disclosure herein, at least the second display screen comprises a display surface 30 in which the display is shared between a first display area 31 and a signaling area 35, as shown in FIG. 3. In a variant shown in FIG. 4, the display is shared, in the display surface 30, between the first display area 31, a second display area 32 and the signaling area 35, the signaling area 35 being located between the first display area and the second display area.

In operation, the control unit 12 commands the display on the screens 18 of the cockpit according to information that it receives, in particular from the avionics computers, and according to interactions with members of the aircraft's crew on the human-machine interface 14. The control unit 12 also monitors the proper operation of the screens 18 via the connections 22, so as to detect potential failure of one of the screens. To this end, it is configured so as to receive information on the state of the screens of the plurality of screens, via the connections 22, and to detect potential failure of a screen according to the state information. In the absence of screen failure, the control unit commands the display on the screens 18 of the cockpit according to a display mode referred to as “normal display mode”. In the event of failure of at least the first display screen of the plurality of screens 18 of the cockpit, the control unit commands the display on the other, functioning, screens of the cockpit according to a display mode referred to as “reconfigured display mode”. Aside from in the event of failure of at least one screen, the reconfigured display mode may also be activated following a voluntary request by the pilot, e.g. to display, on one of the screens of the cockpit, a display window that is normally displayed on a portable device of EFB type, the corresponding display window then being displayed instead of a display window that is normally displayed on this screen of the cockpit in the normal display mode.

In the normal display mode, the control unit 12 commands the display of at least one display window on each screen of the plurality of screens 18 of the cockpit. More specifically, when this screen is similar to the second screen and comprises a first display area 31 and, potentially, a second display area 32, the control unit 12 commands the display of at least one display window in the first display area 31 and of at least one display window in the second display area 32 (when the screen comprises the second display area). When the warning management computer 16 detects the occurrence of an event on board the aircraft, if the flight procedures dictate that this event must be signaled to the members of the aircraft's crew and requires an action on the part of a crew member, then the warning management computer 16 sends information relating to this event to the control unit 12 via the connection 26. The control unit 12 then commands the display of an interactive element in an interaction window and it commands the display of the interaction window on one of the screens of the plurality of screens 18, at least while an action by an operator is required on the interactive element. Thus, a crew member, e.g. a pilot of the aircraft, may use the human-machine interface 14 in order to act on the interactive element so as to carry out the required action. As the interaction window is displayed on one of the screens of the cockpit, the pilot may act on the interactive element in this window subsequent to the occurrence of an event, without having to carry out any action to bring about the display of the interaction window.

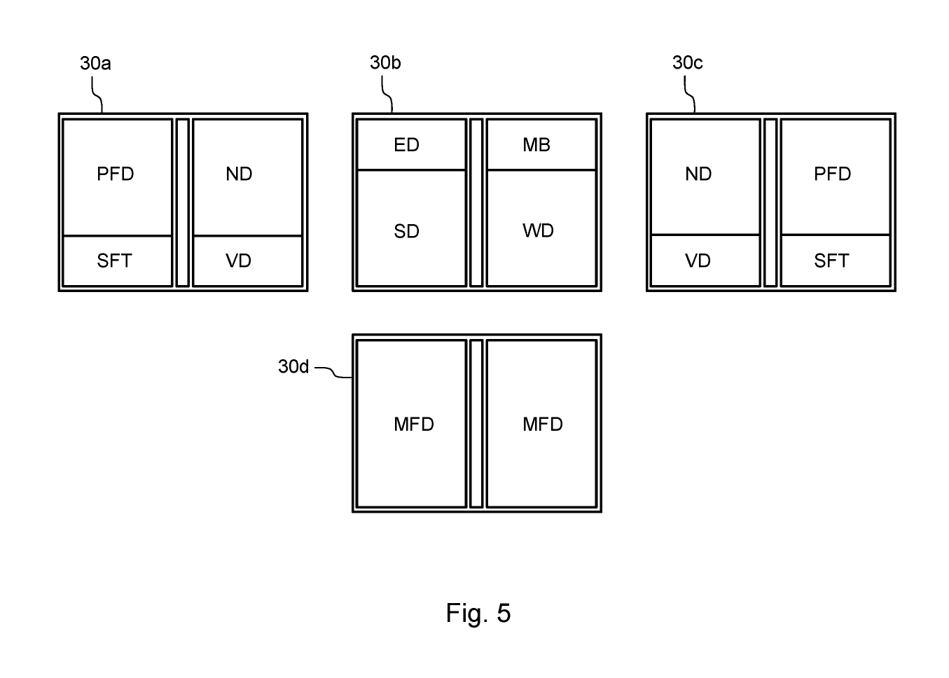

In the example shown in FIG. 5, the cockpit of the aircraft comprises four screens 18 whose respective display surfaces 30a, 30b, 30c and 30d each comprise a first display area (on the left), a second display area (on the right) and a signaling area that is located between the first display area and the second display area. In the normal display mode, the control unit 12 commands the display of display windows in the various display areas of the four screens in such a way that: in the display surface 30a, a display window that is displayed in the first display area comprises two sub-windows corresponding to displays of PFD (Primary Flight Display) and SFT (Slat Flaps and Trim indicator) types, and a display window that is displayed in the second display area comprises two sub-windows corresponding to displays of ND (Navigation Display) and VD (Vertical Display) types; in the display surface 30b, a display window that is displayed in the first display area comprises two sub-windows corresponding to displays of ED (Engine Display) and SD (System Display) types, and a display window that is displayed in the second display area comprises two sub-windows corresponding to displays of MB (MailBox) and WD (Warning Display) types; in the display surface 30c, a display window that is displayed in the first display area comprises two sub-windows corresponding to displays of ND (Navigation Display) and VD (Vertical Display) types, and a display window that is displayed in the second display area comprises two sub-windows corresponding to displays of PFD (Primary Flight Display) and SFT (Slat Flaps and Trim indicator) types; in the display surface 30d, a display window that is displayed in the first display area and a display window that is displayed in the second display area both correspond to displays of MFD (MultiFunction Display) type. On the occurrence of an event on board the aircraft, this event is signaled in the display sub-window of WD type and the interactive element is displayed in this display sub-window which then corresponds to the interaction window.

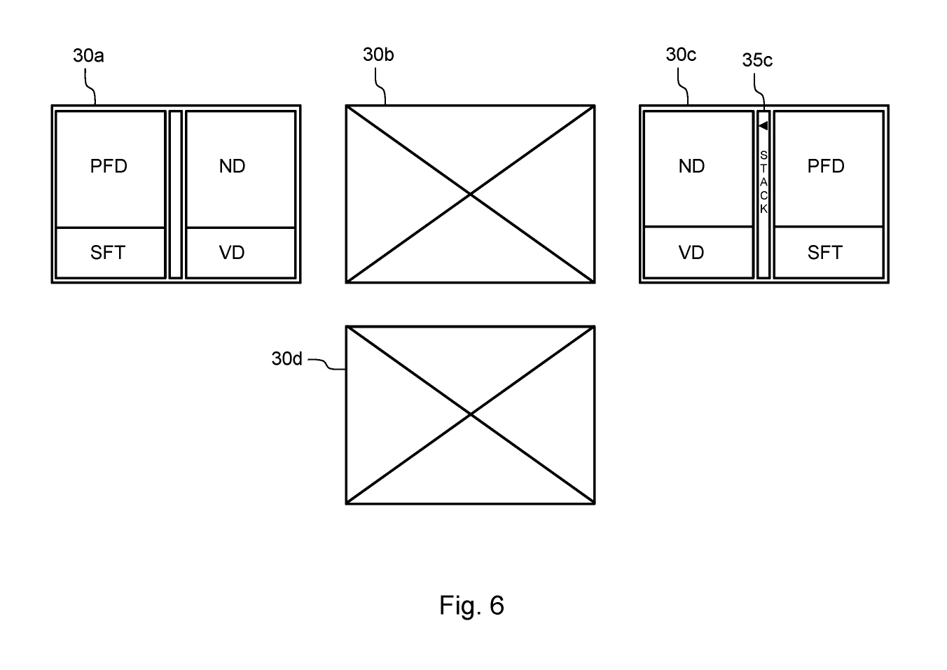

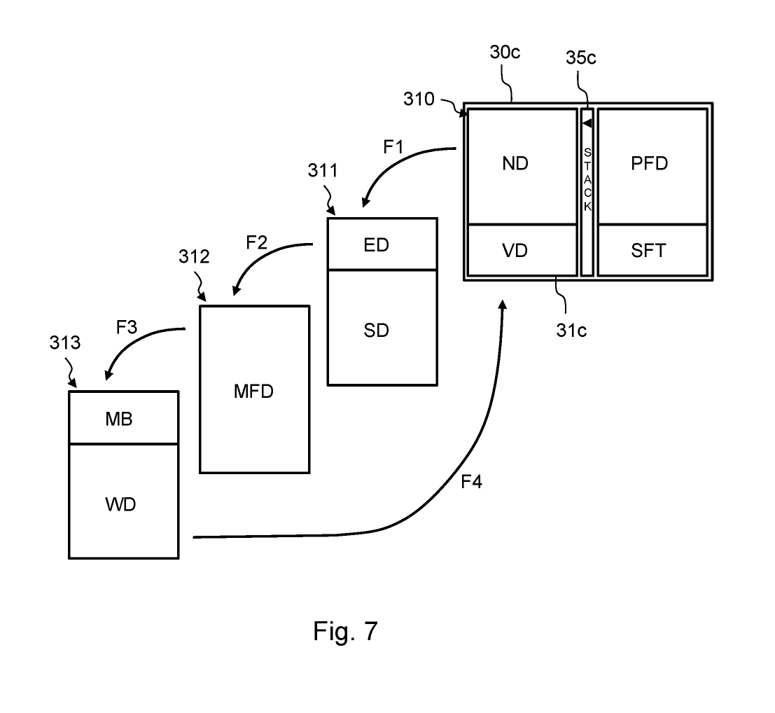

In the reconfigured display mode, the control unit 12 is configured so as to command the display, on the second screen of the plurality of screens, of a display window that is normally displayed on the first screen in the normal display mode. This display window is then displayed on the second screen instead of another display window that is normally displayed on the second screen in normal display mode. More specifically, the control unit commands the display of the window in the first display area 31 or in the second display area 32 of the second screen. According to a first alternative embodiment, the control unit automatically commands the display of the display window on the second screen following the failure of the first screen. This first alternative embodiment corresponds in particular to the case in which this display window is parameterized in the control unit 12 as having priority with respect to the other display window that is normally displayed on the second screen in normal display mode. According to a second alternative embodiment, the control unit commands the display of the display window on the second screen following an action by an operator on the human-machine interface 14 after the failure of the first screen. This second alternative embodiment corresponds in particular to the case in which this display window is parameterized in the control unit 12 as having lower priority with respect to the other display window that is normally displayed on the second screen in normal display mode. This second alternative embodiment is illustrated by the example shown in FIG. 6. This example corresponds to the display illustrated in FIG. 5, when the two central screens are non-functioning. Consequently, the corresponding display surfaces 30b and 30d are no longer operational and the displays of ED, SD, MB, WD and MFD types are therefore not available. The displays of ND, VD, PFD and SFT types are parameterized in the control unit 12 as having priority with respect to the aforementioned display types. Consequently, the display windows that are displayed in the display surfaces 30a and 30c of the functioning screens remain unchanged after the failure of the two central screens, as long as no action in this regard is carried out on the human-machine interface 14 by an operator such as a pilot of the aircraft. Throughout the remainder of the description, it is assumed that the second screen corresponds to the screen shown on the right in FIG. 6, to which the display surface 30c corresponds. When the control unit 12 receives, via the connection 24, information originating from the human-machine interface 14 relating to an action by an operator on the human-machine interface 14, the control unit 12 commands a change of the display window displayed in the first display area 31c of the second screen. Successive actions by the operator on the human-machine interface 14 allow the successive display of the display windows that are normally displayed on both central screens in the normal display mode to be commanded, as shown in FIG. 7. The control unit 12 comprises a memory containing an ordered list of display windows 310, 311, 312 and 313, the memory commanding the display thereof in the first display area 31c during the successive actions by the operator on the human-machine interface 14. Thus, before an action by the operator on the human-machine interface, the display window 310 corresponding to the displays of ND and VD types remains displayed in the display area 31c. The effect of a first action on the human-machine interface is to replace the display window 310 with the display window 311 corresponding to the ED and SD display types, as illustrated by the arrow F1. The effect of a second action on the human-machine interface is to replace the display window 311 with the display window 312 corresponding to the MFD display type, as illustrated by the arrow F2. The effect of a third action on the human-machine interface is to replace the display window 312 with the display window 313 corresponding to the MB and WD display types, as illustrated by the arrow F3. A fourth action on the human-machine interface allows a return to the display of the display window 310 as shown by the arrow F4.

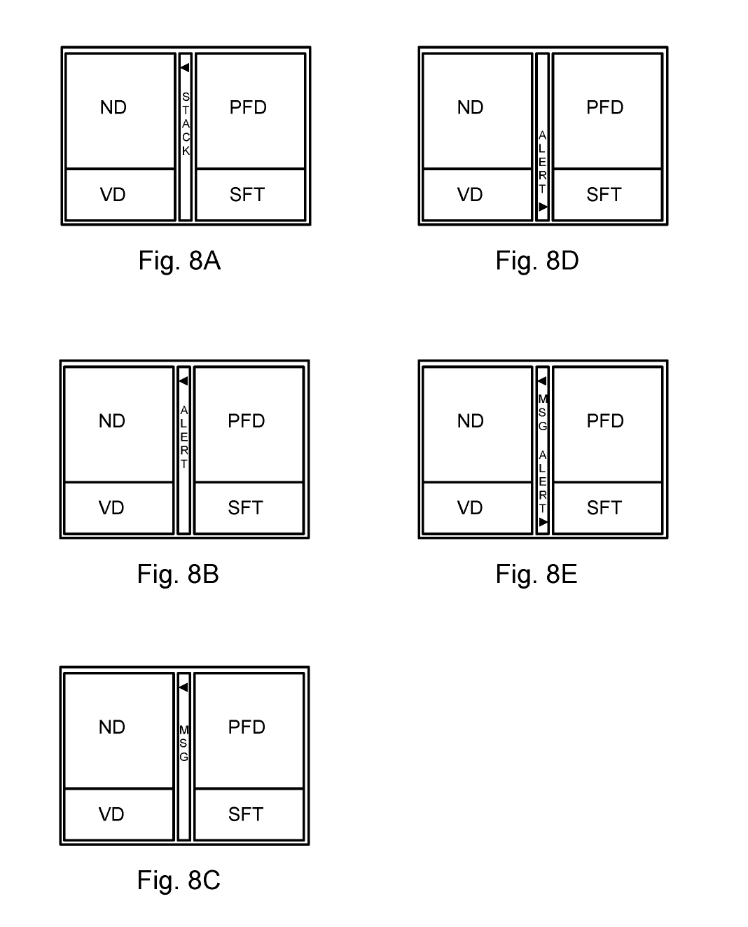

Subsequent to the occurrence of an event on board the aircraft, the control unit 12 commands the display of an indicator in the signaling area 35c of the second screen if the interaction window is not displayed on a screen of the plurality of screens 18 when an action by an operator is required on the interactive element. FIG. 8B illustrates the display, in the signalling area 35C, of a warning indicator ALERT that is associated with the display area 31c of the second screen. The operator, in particular a pilot of the aircraft, is thereby informed that an event has occurred on board the aircraft and that he or she must carry out an action in the interaction window. An action by the operator on the human-machine interface 14 then allows the display window 313 to be directly displayed in the first display area 31c of the second screen, instead of the display window 310. The display window 313 contains the display sub-window of WD type corresponding to the interaction window. Consequently, subsequent to the occurrence of an event on board the aircraft, a single action by the operator is sufficient to access the display of the interaction window, instead of three successive actions as illustrated by the arrows F1, F2 and F3 in the example of FIG. 7. The operator may then take note of the occurrence in the interaction window and carry out the required action by acting on the interactive element of the interaction window by the human-machine interface 14. The action required on the interactive element corresponds, for example, to an acknowledgment of a warning or a modification in the state of a system of the aircraft (e.g. the shutdown of an engine, the opening or closing of a valve, etc.). Advantageously, display attributes of the warning indicator ALERT, such as its color or the display type (fixed or flashing, etc.) depend on the importance of the event parameterized in the control unit 12. For example, the indicator may be displayed in red for the most important events and in yellow for less important events.

Various variants are possible for the human-machine interface 14. This may, for example, correspond to a push-button, to a pointing device such as a trackball, a touchscreen, etc.

Advantageously, the signaling area 35c comprises an interactive element that is actionable using the human-machine interface 14. When the human-machine interface 14 corresponds to a pointing device, this interactive element corresponds to a portion of the signaling area in which an operator may click. When the human-machine interface 14 corresponds to a touchscreen, the interactive element corresponds to a sensitive surface of the touchscreen, this sensitive surface being defined in the signaling area. Depending on the case, the action of the operator on the human-machine interface 14, subsequent to which the control unit 12 commands the display of the interaction window, then corresponds to an action consisting of clicking on the interactive element or touching the sensitive surface of the interactive element. Acting directly on the interactive element that is located in the signaling area to command the display of the interaction window allows the ergonomics to be improved and the workload of the operator to be reduced.

In one advantageous embodiment, when the control unit 12 commands the display on the screens of the cockpit according to the reconfigured display mode, the control unit commands the display of an indicator in the signalling area 35c, even when no action by an operator is required on the interactive element. The display of such an indicator is illustrated in FIGS. 6, 7 and 8A by the indicator STACK that is envisaged to inform an operator that a stack of non-displayed display windows is available for display, these display windows being able to be displayed by actions on the human-machine interface 14 as explained with reference to FIG. 7. This allows the operator to more easily take note of the fact that the reconfigured display mode has been activated and that he or she may request to view other display windows via actions on the human-machine interface.

In one particular embodiment, the control unit 12 additionally commands the display of a specific indicator in the signaling area 35c when an unread message, originating, for example, from air traffic control, is displayed in the display sub-window of MB type while this window is not displayed. This particular embodiment is illustrated in FIG. 8C by the display of the indicator MSG in the signaling area 35c. Preferably, during an action by an operator on the human-machine interface 14 while this indicator MSG is displayed, the control unit 12 directly commands the display of the display window 313 comprising the display sub-window of MB type, in order to reduce the workload of the operator. Advantageously, the indicator MSG is displayed in a specific color, e.g. blue.

When the signaling area is shared between two display areas of one and the same screen, as in the examples shown in FIGS. 4, 5, 6, 7 and 8A to 8E, when it commands the display of an indicator in the signaling area, the control unit additionally commands the display of a symbol associated with this indicator. This symbol is shaped so as to allow an operator to understand to which of the two display areas the indicator corresponds. This symbol may, for example, correspond to an arrow or to a triangle pointing toward the corresponding display area. Thus, in FIGS. 6, 7, 8A, 8B and 8C, this symbol corresponds to a triangle pointing toward the first display area (on the left of the screen) so as to inform an operator that an action on his or her part on the human-machine interface 14 will have the effect of modifying the display window that is displayed in the first display area. In FIG. 8D, this symbol corresponds to a triangle pointing toward the second display area (on the right of the screen) so as to inform an operator that an action on his or her part on the human-machine interface 14 will have the effect of modifying the display window that is displayed in the second display area.

In one particular embodiment shown in FIG. 8E, the signaling area is envisaged to allow the simultaneous display of a first indicator MSG and a second indicator ALERT that respectively correspond to the first display area and the second display area. A first symbol, corresponding to a triangle pointing to the left, is associated with the first indicator and a second symbol, corresponding to a triangle pointing to the right, is associated with the second indicator. Advantageously, a first interactive element that is actionable using the human-machine interface 14 is associated with the first indicator and a second interactive element that is actionable using the human-machine interface 14 is associated with the second indicator. Thus, an action by an operator on the first interactive element allows the display of the display sub-window of MB type in the first display area and an action by an operator on the second interactive element allows the display of the interaction window in the second display area.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A display system for an aircraft, the display system comprising a plurality of screens in a cockpit of the aircraft, comprising at least a first screen and a second screen, the display system also comprising a control unit configured to command a display on the screens of the plurality of screens according to a normal display mode or according to a reconfigured display mode, such that:
in the normal display mode, the control unit is configured to command display of at least one display window on each of the screens of the plurality of screens, such that subsequent to occurrence of an event on board the aircraft leading to the display of an interactive element in an interaction window, the control unit commands the display of the interaction window on one of the screens of the plurality of screens at least while an action by an operator is required on the interactive element; and
in the reconfigured display mode, the control unit is configured to command display, on the second screen of the plurality of screens, of a display window that is normally displayed on the first screen in the normal display mode,
wherein the second screen of the display system comprises a signaling area and, in the reconfigured display mode, the control unit is configured to command display of an indicator in the signaling area if the interaction window is not displayed on a screen of the plurality of screens when an action by an operator is required on the interactive element.

2. The display system as claimed in claim 1, comprising a human-machine interface connected to a control unit and wherein, in the reconfigured display mode, the control unit is configured to command display of the interaction window when it receives information from the human-machine interface corresponding to an action by an operator on the human-machine interface.

3. The display system as claimed in claim 2, wherein the control unit is configured to command the display of the interaction window on the second screen when it receives information from the human-machine interface corresponding to an action by an operator on the human-machine interface.

4. The display system as claimed in claim 2, wherein the signaling area comprises an interactive element that is actionable using the human-machine interface.

5. The display system as claimed in claim 2, wherein the control unit comprises a memory containing an ordered list of display windows that are associated with a second screen in the reconfigured display mode and the control unit is configured to modify the display of the second screen, in the reconfigured display mode, during an action by an operator on the human-machine interface:
by displaying, on the second screen, a display window that is consecutive, in the ordered list, to a current window that is displayed during the action by the operator on the human-machine interface, when no action by an operator is required on the interactive element; and
by displaying, on the second screen, the interaction window when an action by an operator is required on the interactive element.

6. The display system as claimed in claim 5, wherein the ordered list of display windows contains the interaction window.

7. The display system as claimed in claim 1, wherein the second screen comprises a first display area and a second display area, each suitable for displaying at least one display window, and the signaling area is positioned between the first display area and the second display area.

8. The display system as claimed in claim 7, wherein the signaling area is able to be configured to be combined with the first display area and/or the second display area.

9. The display system as claimed in claim 1, wherein the control unit is configured to receive information on the state of the screens of the plurality of screens and to detect potential failure of a screen according to the state information, the control unit furthermore being configured to command the display on the screens of the plurality of screens according to the normal display mode in the absence of screen failure and to command the display on the screens of the plurality of screens according to the reconfigured display mode in the event of failure of at least one screen of the plurality of screens.

10. An aircraft comprising a display system as claimed in claim 1.

11. A display method for an aircraft having a display system comprising a plurality of screens in a cockpit of the aircraft, comprising at least a first screen and a second screen, the display system also comprising a control unit, the control unit commanding a display on the screens of the plurality of screens according to a normal display mode or according to a reconfigured display mode, such that:
in the normal display mode, the control unit commands display of at least one display window on each of the screens of the plurality of screens, in such that subsequent to occurrence of an event on board the aircraft leading to the display of an interactive element in an interaction window, the control unit commands the display of the interaction window on one of the screens of the plurality of screens at least while an action by an operator is required on the interactive element; and
in the reconfigured display mode, the control unit commands display, on the second screen of the plurality of screens, of a display window that is normally displayed on the first screen in the normal display mode,
in which display method, the second screen comprising a signaling area, in the reconfigured display mode the control unit commands the display of an indicator in the signaling area if the interaction window is not displayed on a screen of the plurality of screens when an action by an operator is required on the interactive element.
